(19) United States
(12) Patent Application Publication
(10) Pub. No.: US 2008/0165950 A1
(43) Pub. Date: Jul. 10, 2008

(54) Switchable transmission device for VDSL CO/CPE circuit

(76) Inventor: Ko-Jen Chang, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/812,825

(22) Filed: Jun. 22, 2007

(30) Foreign Application Priority Data
Jan. 10, 2007 (TW) 96100986

(51) Int. Cl. H04M 1/00

(52) U.S. Cl. 379/399.01

(57) ABSTRACT

A switchable transmission device for the VDSL CO/CPE circuit is disclosed. A new hybrid filtering means is used to integrate a CO transmission set and a CPE transmission set into a single device. A switching unit is in charge of switching the functions. A VDSL controlling unit of the preferred embodiment operates the integration of the filtering function between the CO or the CPE transmission sets, and a CO/CPE circuit switching unit operates the circuit switching. After that, the filtered signal is transmitted to an output circuit filtering unit, and outputted via a communication port connect unit subsequently. Furthermore, a status displaying unit displays the operation status of the device. The switchable transmission device for the VDSL CO/CPE circuit can efficiently combine the LANs through existed telephonic copper wires.

### BACKGROUND OF THE INVENTION

1. Field of the Invention

The present invention relates to a switchable transmission device for VDSL CO/CPE circuits, and more particularly to the switchable transmission device in a CO end or a CPE end in combination with a CO/CPE circuit switching unit and a hybrid filtering unit.

2. Description of Related Art

VDSL (Very High Bit-Rate DSL) is the fastest xDSL technology of the present day. When VDSL proceeds a symmetric transmission in bidirectional-constant speed, the transmission rate changes based on the length of the line thereof. Particularly, VDSL is primarily applied for signal transmission of fiber optical networks. The background technology is described below.

Reference is made to FIG. 1 showing a structural diagram of a current VDSL system, which has a CPE (Customer Premises Equipment) end X (for home use) and a CO (Central Office) end Y (for a telecommunication company). The telephonic copper wire 101 is a fundamental structure, that is, a CPE transmission device and a CO transmission device are linked with each other by means of the wire 101. Since the telephonic copper wire 101 can carry voice signals and data signals simultaneously, VDSL technology not only provides high-speed data transmission, but also carries telephonic voice data.

In an embodiment of a VDSL system as shown in FIG. 1, the CPE transmission device 11 is in charge of signal splitting, specifically separating the signal into data and voice signals which are then carried on the telephonic copper wire 101. That is, the high frequency and low frequency, which respectively carry the data and voice, are filtered. The CPE transmission device 11 is used to retrieve voice signals from the transmitted signals and transfer the voice signals to the indoor telephone 13. Next, voice signals from the telephone 13 are transferred to the CO end Y through the CPE transmission device 11. Furthermore, the CPE transmission device 11 also transfers the data signals to an ADSL transceiver unit remote (ATU-R) 14 on the other side. Next, the data signals are under digital-analog conversion and demodulation. After those processes, the data signals are transferred to the CPE transmission device 11, next to the CO end Y In practice, signal splitting means are provided from the CPE transmission device 11 which transfers and combines the voice and data signals, or receives the original data and separates them into voice and data signals.

Likewise, the device in the CO end Y connects the CPE transmission device 11 in the CPE end X via the CO transmission device 12. The CO transmission device 12 is also in charge of the means for signal splitting, which separates the voice and data signals from the CPE end X. Particularly, voice signals are transferred to a PSTN 18 through a voice switch 16. Next, the data signals separated by the CO transmission device 12 are transferred to a DSL access multiplexer (DSLAM) 17, which can efficiently integrate the IP network and the ATM network 19 shown in figure. Finally, the signals are transferred to an ISP (Internet service provider) 191 or a business end 193. Similar to the above-mentioned CPE transmission device 11, the signal splitting means provided in the CO transmission device 12 combines the voice and data signals and transfers them, or receives the signals and separates them.

In the described VDSL system, the CPE end X and the CO end Y respectively use the transmission devices 11, 12 have different splitting functions, and connect with each other via the telephonic copper wire 101. However, to form a VDSL system, both ends thereof set up the CO transmission device as a master and the CPE transmission device as a slave. Reference is made to FIG. 2, which shows an embodiment of circuitry of the CO transmission device having a signal splitting function. Moreover, a plurality of passive devices, such as an inductor, a capacitor and a resistor, form a CO-end first circuitry 201 having TX and RX ends and a CO-end second circuitry 202 having a transformer 20 and a filtering circuit. Furthermore, FIG. 3 shows the circuitry of a CPE transmission device with a signal splitting function. Similarly, a plurality of passive devices are used to form a CPE-end first circuitry 301 having TX and RX ends and a CPE-end second circuitry 302 having a transformer 30 and a filtering circuit.

Conventionally, optical fiber can be introduced to implement VDSL transmission. Thus, VDSL system achieves a high-speed transmission via common telephonic copper wires, and is in charge of carrying voice and data signals.

It is necessary to separate the CO end and the CPE end via a transmission device using VDSL point-to-point transmission technology. Since the filtering means of the CO end and the CPE end are different, the two ends can not be efficiently combined into a single device.

### SUMMARY OF THE DISCLOSURE

The present invention introduces a new hybrid filtering means to integrate the transmission devices respectively in a CO end and a CPE end, into a single box, besides incorporating the features of conventional VDSL transmission. Furthermore, a switch of the present invention is used to configure the CO end as a master and the CPE end as a slave. Since the technology provided by the present invention merely carries data signals and not voice signals, the circuitry is simplified so as to integrate the current telephonic copper wire and local area network efficiently.

Because the filtering means used in the CPE transmission device and the CO transmission device are different, two different circuitries are required for their combination. However, the switchable transmission device for the VDSL CO/CPE circuit described in the present invention integrates an improved filtering unit having only one filtering circuit set and a CO/CPE circuit switching unit. After that, the CO/CPE circuit switching unit makes one device operate either the transmitting functionalities of the CO end or the CPE end.

The switchable transmission device for the VDSL CO/CPE circuit of the preferred embodiment of the present invention has a CO/CPE circuit switching unit, a status displaying unit, a VDSL mastering unit, a CO/CPE signal filtering unit, an output circuit filtering unit, and a communication port connecting unit. The switchable transmission device uses the CO/CPE circuit switching unit to process the switching between the CO-end and CPE-end circuits, so only one box is required to control the CO/CPE signal filtering unit. The status displaying unit electrically connects with the CO/CPE circuit switching unit and VDSL mastering unit, which includes a plurality of signaling lights to show the operating conditions. The signals filtered by the CO/CPE signal filtering unit are transmitted to the output circuit filtering unit, and the communication port connecting unit performs the input/output of signals at the master and slave ends.

Another embodiment of the present invention includes a VDSL mastering unit that can be a chipset, which controls the switching of the switchable transmission device based on the received switching signal. Furthermore, one switch is used to switch a CO/CPE circuit switching unit. Furthermore, a status displaying unit electrically connects with a CO/CPE circuit switching unit and a VDSL mastering unit for displaying the operating conditions of the device. A hybrid filtering unit is made of the combination of a CO/CPE signal filtering unit and the filtering circuits at the CO end and the CPE end. Moreover, the switchable transmission device has a telephone line port with an RJ-11 format, and an Ethernet network port with an RJ-45 format.

### BRIEF DESCRIPTION OF DRAWINGS

The present invention will be readily understood by the following detailed description in conjunction accompanying drawings, in which:

FIG. 1 shows a structural diagram of the network for the VDSL system of the prior art;

FIG. 2 shows a schematic diagram of the CO-end transmission device of the prior art;

FIG. 3 shows a circuit diagram of the CPE-end transmission device of the prior art;

FIG. 4A is a schematic diagram of a switchable transmission device for the VDSL CO/CPE circuit of the present invention;

FIG. 4B-4C is a schematic diagram of a panel of the switchable transmission device for the VDSL CO/CPE circuit of the present invention;

FIG. 5 shows a network structural diagram of the switchable transmission device for the VDSL CO/CPE circuit of the present invention;

FIG. 6 shows a schematic diagram of the embodiment of the present invention applied to buildings;

FIG. 7 shows a block diagram for each part of the switchable transmission device for the VDSL CO/CPE circuit of the present invention;

FIG. 8 is a schematic diagram of the embodiment of the switchable transmission device for the VDSL CO/CPE circuit of the present invention;

FIG. 9 shows a CO/CPE signal filtering unit of the present invention;

FIG. 10 is a schematic diagram of a CO/CPE circuit switching unit of the present invention.

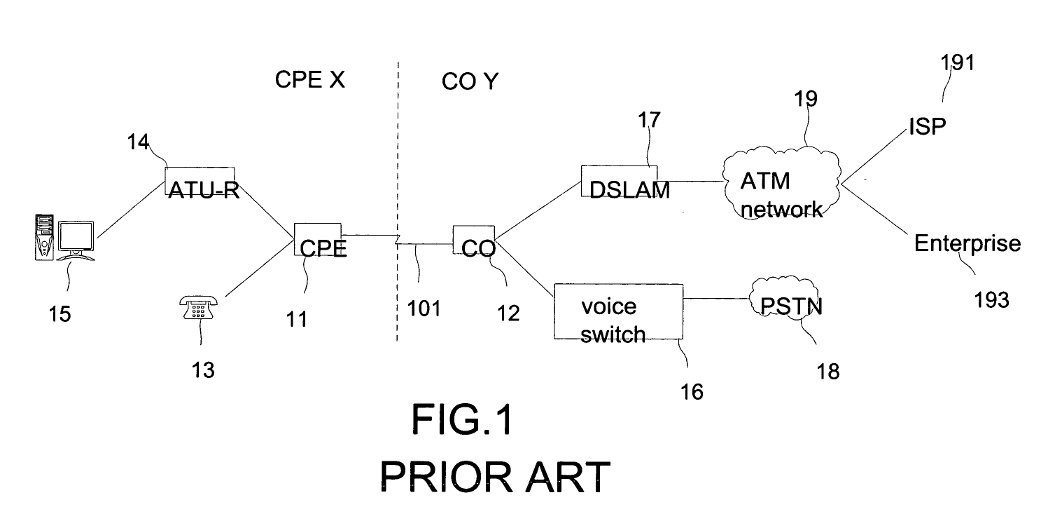

### DETAILED DESCRIPTION OF THE PREFERRED EMBODIMENTS

For further understanding of the invention, please refer to the following detailed description illustrating the embodiments and examples of the invention. The description is only for illustrating the invention and is not intended to be considered limiting the scope of the claim.

The claimed invention provides a switchable transmission device for a VDSL CO/CPE circuit, whereby the switchable transmission devices in the CO end and in the CPE end are integrated into one device. Next, a local area network (LAN) can easily connect to a remote network via the switchable transmission device. Particularly, this switchable transmission device can be regarded as a network bridge device between the LANs.

The mentioned switchable transmission device for a VDSL CO/CPE circuit essentially features integrating the CO-end circuit and the CPE-end circuit into one box, and processing switching functions by a switch sending a chipset a command. Next, the chipset operates a configuration to a filtering means for both a CO end and a CPE end, thereby implementing a high speed connection by means of point-to-point DSL technology. Furthermore, under the conditions of using common telephonic copper wire, the present invention still performs an effective transmission rate of 30 Mbps between two ends over 600 meters apart, and no more new kinds of wires are needed. The switchable transmission device of the present invention can be configured as a master CO-end transmission device, or a slave CPE-end transmission device. Moreover, the wire between the two ends only carries data signals and not conventional voice signals, so the circuitry thereof can be simplified and integrated.

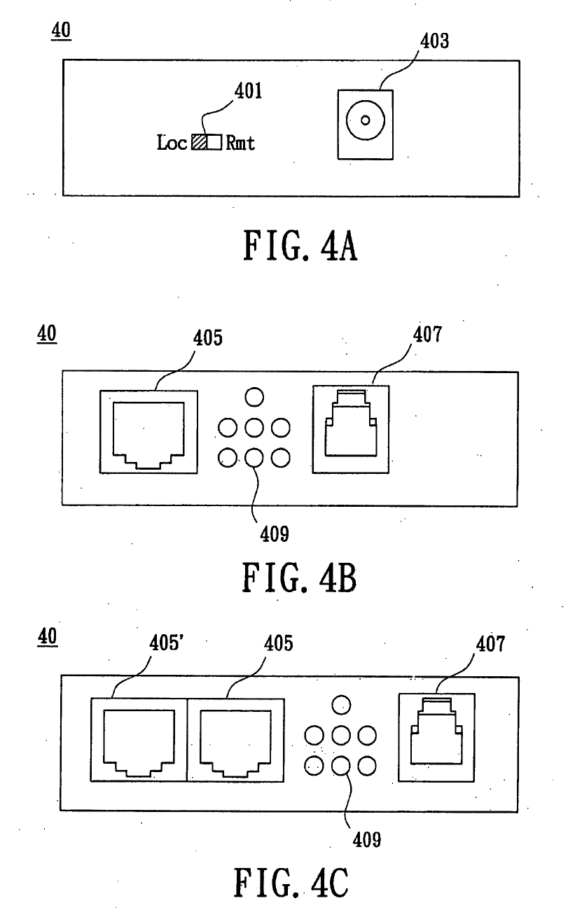

The mentioned switch operates between the CO-end circuit and the CPE-end circuit. The switching operation is implemented by a chip. The signal via the switchable transmission device is filtered by a new hybrid filtering unit. The schematic diagrams of the preferred embodiment of the present invention are shown in FIG. 4A to 4C which show the diagrams of the panels for the switchable transmission device for the VDSL CO/CPE circuit, wherein the panel has every kind of connecting port, switch and a signaling light for displaying its operating status.

FIG. 4A shows a schematic diagram of the panel of the switchable transmission device 40 for a VDSL CO/CPE circuit. The housing part of the device includes at least one panel having a controlling device and a communication port, such as a selection switch 401 and a power plug 403 as shown in the diagram. A user can switch the selection switch 401 to select one of the functions for the switchable transmission device. An Loc-end and an Rmt-end as shown in the diagram are included. When the device is switched to the Loc-end, the switchable transmission device is switched to a CO-end switchable transmission device; when the device is switched to the Rmt-end, the device is switched to a CPE-end switchable transmission device. Moreover, the power plug 403 is disposed on the panel of the switchable transmission device, so as to connect to an external power source.

FIG. 4B shows another schematic diagram of another panel of the switchable transmission device 40 for a VDSL CO/CPE circuit. This panel has a plurality of communication ports, wherein an Ethernet network port 405 in compliance with an RJ-45 format and a telephone line port 407 with an RJ-11 format are included. In the preferred embodiment of the present invention, the Ethernet network port 405 connects to an entry of an internal network, such as a router, a switch, a hub or the like. Furthermore, the telephone line port 407 connects to a telephone line port of another switchable transmission device 40 for a VDSL CO/CPE circuit. After that, those connections introduce a network structure with a combination of two or more local area networks. Furthermore, the mentioned telephone line port 407 can connect to one splitter for simultaneously transferring both voice and data signals. Moreover, the switchable transmission device 40 includes a status signaling light having a plurality of LEDs for displaying the status of a network connection, a device operation, a power supply. Furthermore, a displaying monitor can be used to display the above-mentioned statuses in other embodiments.

Another embodiment of the switchable transmission device (40) is shown in FIG. 4C. The panel thereon has at least one telephone line port 407, and two or more Ethernet network ports 405, 405′. The device 40 of the present embodiment can be implemented as a network switch. The device 40 uses the telephone line port 407 to connect to other networks extended by the claimed switchable transmission device 40, and uses plural Ethernet network ports 405, 405′ to connect to plural internal network devices. In the meantime, the signaling light 409 can display the status of network connection, device operation or power supply. The practical implementation can not be confined to the above-mentioned number.

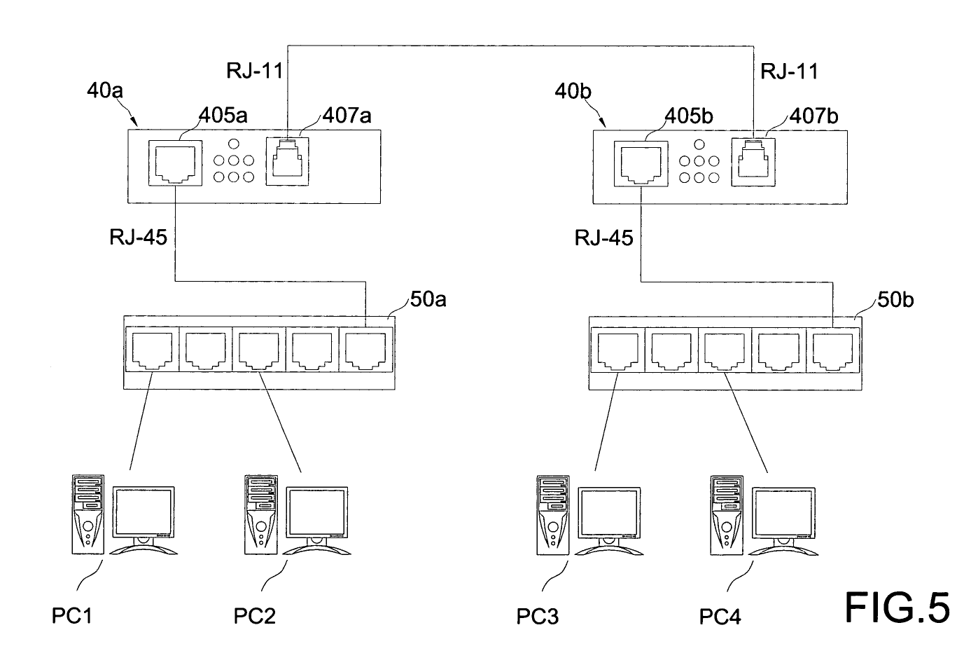

Reference is made to FIG. 5, which shows a network structure of the connection between two switchable transmission devices for a VDSL CO/CPE circuit of the present invention. This figure shows a first switchable transmission device 40a and a second switchable transmission device 40b. One of the embodiments configures the first switchable transmission device 40a as a CO-end switchable transmission device by the switch, and the second switchable transmission device 40b as a CPE-end switchable transmission device. After that, these two devices are connected with each other via the telephone line.

For example, a first Ethernet network port 405a of the first switchable transmission device 40a connects to a first network device 50a via an RJ-45 cable, wherein the first network device 50a can be a router, a switch, a hub or a device capable of network connection. The network device has a plurality of network ports connecting with a plurality of terminal computers, such as the computers PC1 and PC2 shown in diagram. The second switchable transmission device 40b has a similar structure, and a second Ethernet network port 405b thereon connects to a second network device 50b via the RJ-45 cable. This second network device 50b can be a router, a switch, a hub or a device with the functions of a network connection. This device 50b also has a plurality of network ports connecting to the terminal computers PC3 and PC4. The CO-end switchable transmission device and the CPE-end switchable transmission device, namely the first switchable transmission device 40a and the second switchable transmission device 40b, are connected with each other via a first telephone line port 407a and second telephone line port 407b. Therefore, the switchable transmission device of the present invention can be extended.

Oppositely, another embodiment of the present invention configures the first switchable transmission device 40a as the CPE-end switchable transmission device, and the second switchable transmission device 40b as the CO-end switchable transmission device. Furthermore, the mentioned network device 50a or 50b can connect with one or more terminal computers by means of wireless connection.

This switchable transmission device for VDSL CO/CPE circuit is originally applied for the high-speed connection for a business or personal use that is the structure of the CO-end and CPE-end devices. However, the switchable transmission device of the preferred embodiment is applied to form a local area network (LAN), such as the architecture shown in FIG. 5.

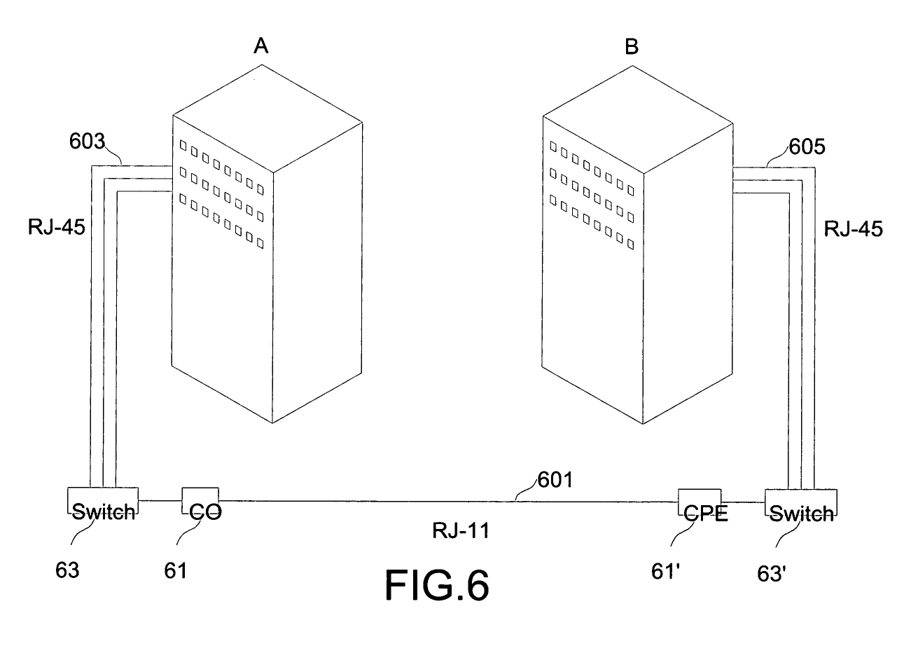

If the connection between two buildings requires a transmission rate with a greater bandwidth, such as the example shown in FIG. 6, the network between building A and building B forms a point-to-point network via the switchable transmission devices (61, 61′) for a VDSL CO/CPE circuit. These two ends at the two buildings are configured as a CO-end transmission device and a CPE-end transmission device respectively, and vice versa, the switchable transmission device 61 can be configured as the CPE-end transmission device, and the device 61′ can be the CO-end transmission device. Next, the two telephone line ports of the devices (61, 61′) are connected to each other via the telephonic copper wire in compliance with an RJ-11 format.

In the figure, the Ethernet network ports of the two switchable transmission devices for a VDSL CO/CPE circuit connect to the LANs in building A and building B via the switches 63, 63′ or other network devices, for example, the hub. Specifically, the cable in compliance with an RJ-45 format is used to bridge the two buildings. A wire or wireless connecting means can implement the connection which forms a local area network for the buildings.

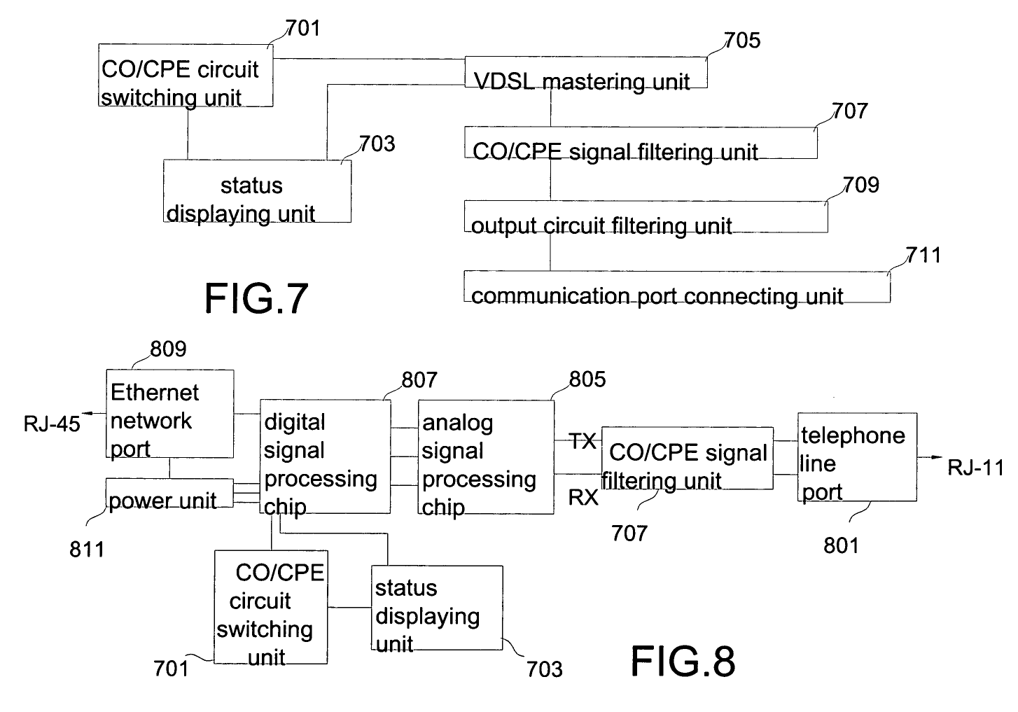

For implementing the object of the present invention to have one device with a signal splitting function for both the CO end and the CPE end, a hybrid filtering unit disposed in the switchable transmission device for VDSL CO/CPE circuit replaces the filters respectively operated in the CO-end and the CPE-end transmission devices. Reference is made to FIG. 7 which shows a functional diagram of the device.

In FIG. 7, a CO/CPE circuit switching unit 701, a status displaying unit 703, a VDSL mastering unit 705, a CO/CPE signal filtering unit 707, an output circuit filtering unit 709, and a communication port connecting unit 711 are included in the switchable transmission device. In particular, the CO/CPE circuit switching unit 701 is used to switch the CO-end and CPE-end circuit, and the CO/CPE signal filtering unit 707 is used to filter the transmitted signals. Furthermore, the CO/CPE signal filtering unit 707 couples to a VDSL mastering unit 705, and is implemented as a new hybrid filtering unit for improving the conventional transmission device and integrating the filtering circuits of the conventional CO-end and CPE-end transmission devices. Since the hybrid filtering unit can perform signal filtering for the CO-end or the CPE-end transmission device, the filtering means for the CO end and the CPE end can be implemented in a single box.

Since the mentioned CO/CPE circuit switching unit 701 can be implemented as a switch having a switching circuit, users can thereby switch the circuitries of the switchable transmission device. When the CO/CPE circuit switching unit 701 receives a switching command, a switching signal is sent out and forwarded to the VDSL mastering unit 705. Therefore, the switching function provided by the switchable transmission device for VDSL CO/CPE circuit is performed. The preferred embodiment of the VDSL mastering unit 705 is a chipset which controls the CO/CPE signal filtering unit 707. The CO/CPE signal filtering unit 707 filters the signals at the CO end or the CPE end according to the switching signal. Furthermore, the status displaying unit 703, which electrically couples with the CO/CPE circuit switching unit 701 and VDSL mastering unit 705, retrieves the signals therebetween and displays the operating status with a plurality of signaling lights. The status displaying unit 703 shows the status of the selected circuit (CO or CPE) after switching, current connection, operation of the device, and power supply. In the preferred embodiment, blinking or color variation of a plurality of LEDs notifies users of the operating status for the switchable transmission device for a VDSL CO/CPE circuit.

After the VDSL mastering unit 705 activates the CO/CPE signal filtering unit 707 to switch the circuits, the signals filtered by the CO/CPE signal filtering unit 707 are transmitted to a communication port, such as the above-mentioned telephone line port, so as to connect to an external network or a remote device (opposite to the CO end or the CPE end). In the period of connecting to the external network via the communication port, the signals pass through the output circuit filtering unit 709, which are transmit or receive the data transmitted by the communication port connecting unit 711. The preferred embodiment of the output circuit filtering unit 709 is applied to a filtering unit for the telephone line, and the preferred embodiment of the communication port connecting unit 711 is a connecting port in compliance with an RJ-11 format. A remote entry of the switchable transmission device corresponds to another switchable transmission device for the VDSL CO/CPE circuit. As in the embodiment shown in FIG. 5, the local device is switched to a CO-end transmission device, and the remote device is switched to a CPE-end transmission device.

Reference is made to FIG. 8, which shows an embodiment of the claimed device. The aforementioned CO/CPE signal filtering unit 707 connects to a telephone line port 801 in compliance with an RJ-11 format. Via this port 801, the remote transmission device is connected. The other end of the CO/CPE signal filtering unit 707 has TX (transmit) and RX (receive) connecting ports, and can thereby connect to an analog signal processing chip 805 and a digital signal processing chip 807. The signals are under a digital-to-analog conversion via the signal processing chips 807 and 805 so the signals can be transmitted in the analog line. Similarly, the signals from the telephone line are processed by the analog-to-digital conversion via the processing chips 805 and 807, so the signals can be transmitted to the Ethernet network.

The CO/CPE circuit switching unit 701, which couples with the digital signal processing chip 807, is used to process switching between the CO-end circuit and the CPE-end circuit so the switchable transmission device for the CO end or the CPE end can be integrated into a single device. The switching signal is then transmitted to the digital signal processing chip 807 and the analog signal processing chip 805. As shown in FIG. 7, the preferred embodiment of the VDSL mastering unit 705 is the chipset which can process both the digital and analog signals. Next, the CO/CPE signal filtering unit 707 filters the CO-end or CPE-end signals based on the switching signal.

Furthermore, the status displaying unit 703 coupling to the CO/CPE circuit switching unit 701 and the digital signal processing chip 807 is introduced to show the current operating status with blinking or color variation of the LEDs.

A mastering unit made of the processing chips 807 and 805 couples to the Ethernet network port 809, and connects to a local area network through a cable with an RJ-45 format. A power unit 811 directly provides the power for the switchable transmission device.

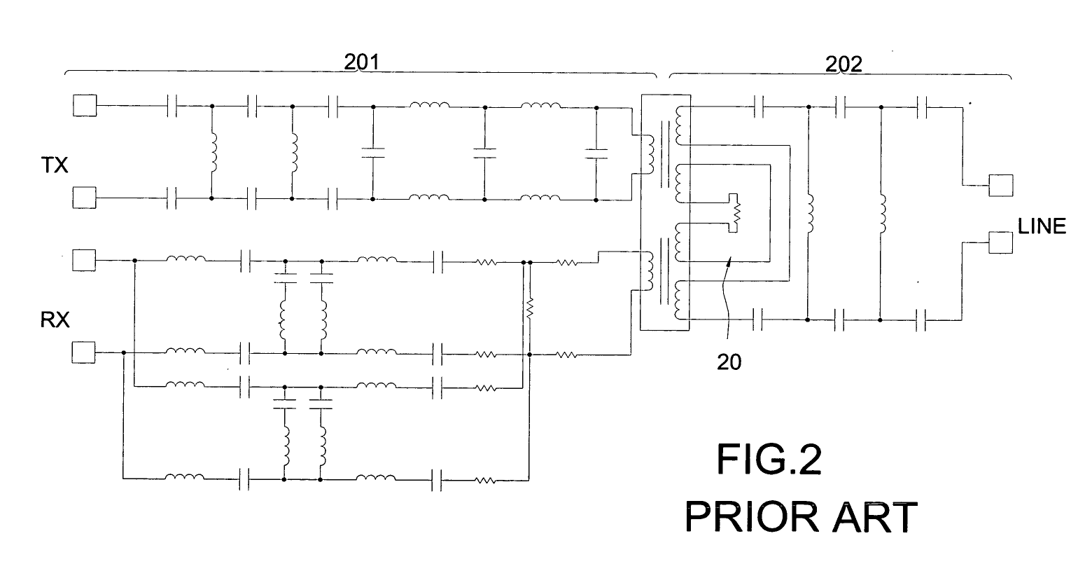

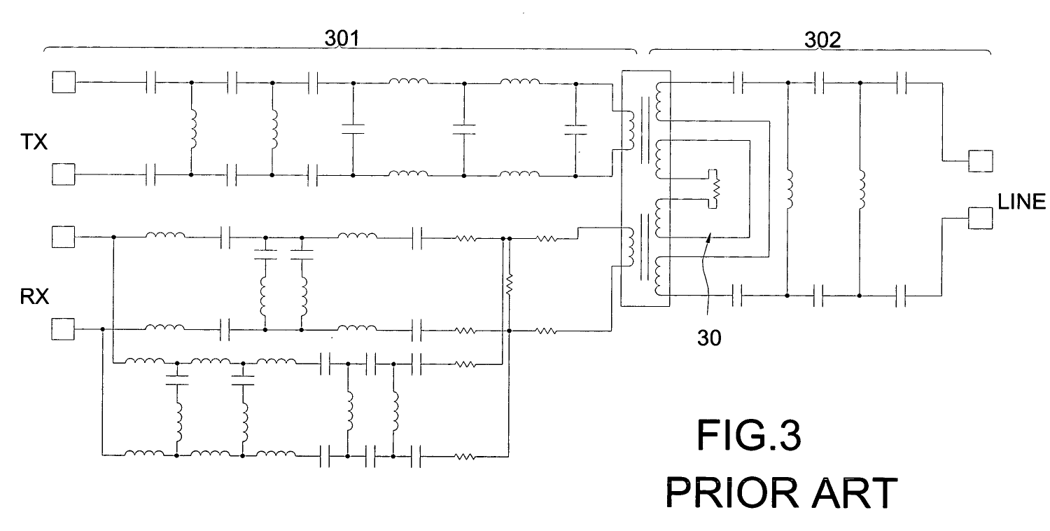

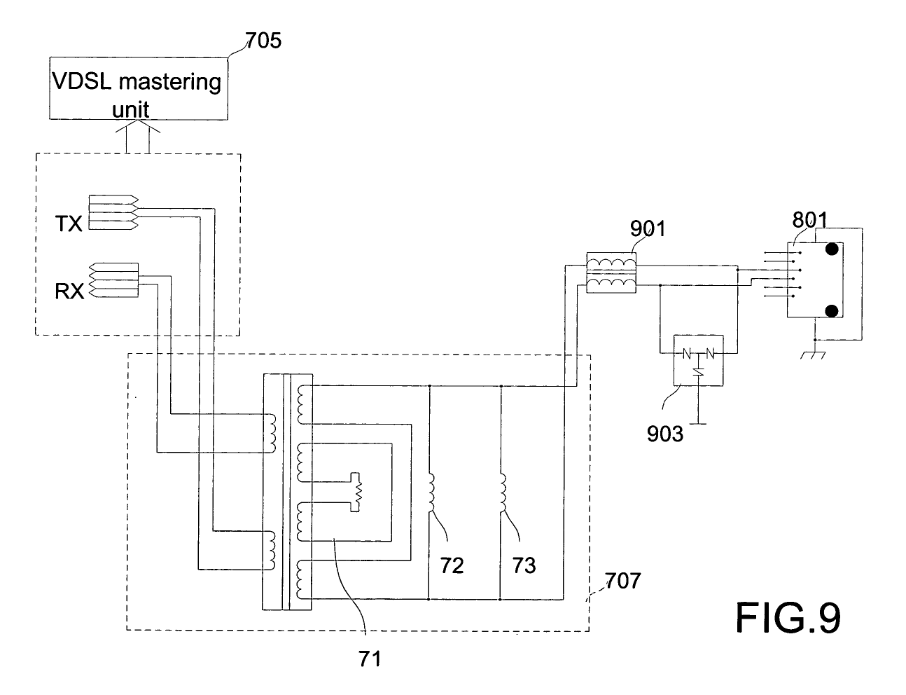

The embodiment of the CO/CPE signal filtering unit 707 is the circuit shown in FIG. 9. The CO/CPE signal filtering unit 707 is made of a set of transformers 71 which connect to the inducting units 72, 73 in parallel. Referring to the circuits of the CO-end transmission device and the CPE-end transmission device shown in the prior art FIGS. 2 and 3 respectively, the CO/CPE signal filtering unit 707 shown in FIG. 9 satisfies the requirements of both the CO end and the CPE end. Therefore the filtering function for respective transmission devices can be integrated.

The transmission ports of the mentioned CO/CPE signal filtering unit 707, which connects to the chipset, are indicated as “TX” (transmit) and “RX” (receive). These transmission ports electrically connect to the VDSL mastering unit 705, which controls the CO/CPE signal filtering unit 707 to be a CO-end (master) filtering means or a CPE-end (slave) filtering means according to the switching signal. The other end of the CO/CPE signal filtering unit 707 electrically connects to the telephone line port 801 via a filtering circuit 901, which is used to filter the common ground noise. The filtering circuit 901, for example, can be implemented as the output circuit filtering unit 709 shown in FIG. 7. The preferred embodiment of the telephone line port 801 is a communication port in compliance with an RJ-11 format. Furthermore, a grounding circuit 901, which is in charge of diminishing a surge, is disposed between the telephone line port 801 and the CO/CPE signal filtering unit 707 for preventing noise.

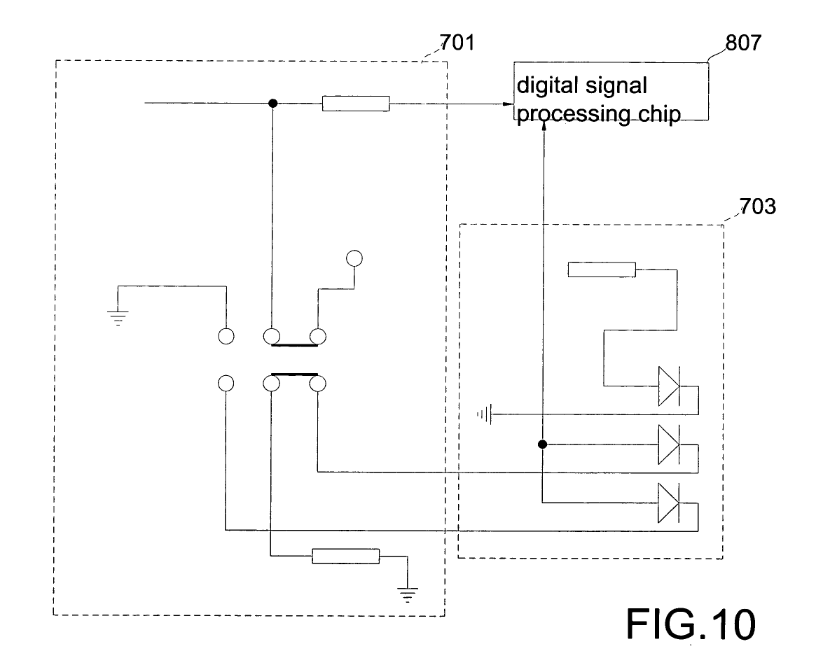

The CO/CPE circuit switching unit 701 is used to switch the transmitting function to the CO end or the CPE end. The circuit therefore shown in FIG. 10 further includes the status displaying unit 703 with a plurality of LEDs, and the other end electrically connects to the digital signal processing chip 807.

To sum up, the present invention essentially features using a switch to configure the CO-end and the CPE-end transmission device. The device can be applied to a telephone line (or the last mile) for network connection, and can easily be extended to two or more LANs. Furthermore, the device uses the features of VDSL to build the backbone of a network on top of conventional telephonic copper wire. The present invention has the advantage of being cheaper than other similar technologies that achieve similar goals.

The many features and advantages of the present invention are apparent from the written description above and it is intended by the appended claims to cover all. Furthermore, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A switchable transmission device for VDSL CO/CPE circuits, which integrates a CO transmission circuit and a CPE transmission circuit into a device by a hybrid filtering means, comprising:
a VDSL mastering unit receiving a switching signal and switching the switchable transmission device to the CO end or the CPE end;
a CO/CPE circuit switching unit coupled to VDSL mastering unit, for producing the switching signal;
a status displaying unit electrically connected to the CO/CPE circuit switching unit and the VDSL mastering unit, so as to display an operating status of the switchable transmission device for VDSL CO/CPE circuits;
a CO/CPE signal filtering unit coupled to the VDSL mastering unit, for filtering the signal of the switchable transmission device for the VDSL CO end or the CPE end after switching; and
a communication port coupled to the CO/CPE signal filtering unit, for connecting to an external network.

2. The switchable transmission device for the VDSL CO/CPE circuit of claim 1, wherein a connection to the communication port passes through an output circuit filtering unit and a communication port connecting unit.

3. The switchable transmission device for the VDSL CO/CPE circuit of claim 2, wherein the communication port connecting unit is a telephone line port.

4. The switchable transmission device for the VDSL CO/CPE circuit of claim 1, wherein the CO/CPE signal filtering unit is a hybrid filtering unit which integrates the filtering circuits in both the CO end and the CPE end.

5. The switchable transmission device for the VDSL CO/CPE circuit of claim 1, wherein the CO/CPE circuit switching unit is a switch of a switching circuit.

6. The switchable transmission device for the VDSL CO/CPE circuit of claim 1, wherein the VDSL mastering unit is a chip set.

7. The switchable transmission device for the VDSL CO/CPE circuit of claim 6, wherein the chip set includes an analog signal processing chip and a digital signal processing chip.

8. The switchable transmission device for the VDSL CO/CPE circuit of claim 1, wherein the status displaying unit adopts a plurality of signaling lights to display the operating status of the switchable transmission device for a VDSL CO/CPE circuit.

9. The switchable transmission device for the VDSL CO/CPE circuit of claim 1, wherein VDSL mastering unit couples to an Ethernet port.

10. The switchable transmission device for the VDSL CO/CPE circuit of claim 9, wherein the Ethernet port uses an RJ-45 cable to link to a local area network.

11. A switchable transmission device for the VDSL CO/CPE circuit, which integrates a CO transmission circuit and a CPE transmission circuit into a device by a hybrid filtering means, comprising:
a VDSL mastering unit, which is a chip set used for receiving a switching signal and switching the switchable transmission device to the CO end or the CPE end;
a CO/CPE circuit switching unit, which is a switch of a switching circuit coupled to VDSL mastering unit, for producing the switching signal;
a status displaying unit electrically connected to the CO/CPE circuit switching unit and the VDSL mastering unit, so as to display an operating status of the switchable transmission device for the VDSL CO/CPE circuit;
a CO/CPE signal filtering unit, which is a hybrid filtering unit integrating the filtering circuits in the CO end and in the CPE end, coupled to the VDSL mastering unit for filtering the signal of the switchable transmission device for the VDSL CO end or the CPE end after switching;
a telephone line port, which is a communication port in compliance with an RJ-11 format, coupled to the CO/CPE signal filtering unit and linking to an external network via a telephone line; and
an Ethernet port coupled to VDSL mastering unit, and using an RJ-45 cable to link to a local area network.

12. The switchable transmission device of claim 11, wherein the CO/CPE signal filtering unit connects with the telephone line port via a filtering circuit which is used to filter a common ground noise.

13. The switchable transmission device of claim 11, further including a ground circuit used to diminish a surge is disposed between the telephone line port and the CO/CPE signal filtering unit.

14. The switchable transmission device of claim 11, wherein the chip set includes an analog signal processing chip and a digital signal processing chip.

15. The switchable transmission device of claim 11, wherein the status displaying unit adopts a plurality of signaling lights to display the operating status of the switchable transmission device for the VDSL CO/CPE circuit.

16. A panel of the switchable transmission device for the VDSL CO/CPE circuit of claim 1, the panel comprising:
a selection switch disposed on the panel of the switchable transmission device for the VDSL CO/CPE circuit, whereby the switchable transmission device is switched to a CO-end transmission device or a CPE-end transmission device;
a power plug disposed on the panel of the switchable transmission device for the VDSL CO/CPE circuit, thereby connecting to an external power source;
at least one Ethernet port disposed on the panel of the switchable transmission device for the VDSL CO/CPE circuit, thereby connecting with the switchable transmission device for the VDSL CO/CPE circuit on the other side;
at least one telephone line port disposed on the panel of the switchable transmission device for the VDSL CO/CPE circuit, thereby connecting to a network domain; and
a signaling light for displaying status disposed on the panel of the switchable transmission device for the VDSL CO/CPE circuit for displaying the operating status of the switchable transmission device.

17. The switchable transmission device of claim 16, wherein the Ethernet port is a communication port in compliance with an RJ-45 format.

18. The switchable transmission device of claim 16, wherein the telephone line port is a communication port in compliance with an RJ-11 format.

19. The switchable transmission device of claim 16, wherein the signaling light for displaying status is implemented as a plurality of LEDs which blink or vary their color.

20. The switchable transmission device of claim 16, wherein the selection switch includes an Loc end and an Rmt end.

21. The switchable transmission device of claim 20, if the selection switch is switched to the Loc end, the CO-end switchable transmission device is enabled; if the selection switch is switched to the Rmt end, the CPE-end switchable transmission device is enabled.
